(19) United States
(12) Patent Application Publication
(10) Pub. No.: US 2021/0084615 A1
(43) Pub. Date: Mar. 18, 2021

(54) METHOD AND APPARATUS FOR MAPPING BEAM PATTERN TO PAGING RESOURCES

(71) Applicant: Sony Corporation, Tokyo (JP)

(72) Inventors: Basuki PRIYANTO, Lund (SE); Anders BERGGREN, Lund (SE)

(21) Appl. No.: 16/970,296

(22) PCT Filed: Jan. 22, 2019
(86) PCT No.: PCT/US2019/014506

§ 371 Date: Aug. 14, 2020

(30) Foreign Application Priority Data
Feb. 15, 2018 (SE) 1830051-7

(51) Int. Cl. H04W 68/02; H04W 72/04; H04W 52/02; H04W 56/00

(52) U.S. Cl. CPC H04W 68/02; H04W 56/001; H04W 52/0216; H04W 72/044

(57) ABSTRACT

Paging for a base station (12) operating in a wireless communication system and using multiple transmit beams includes transmitting a synchronization signal burst set by a beam sweep according to a first beam pattern. The base station determines an allocation of paging resources for a second beam pattern for a paging operation according to a predetermined mapping based on the first beam pattern. The base station transmits a paging message according to the second beam pattern using paging resources determined with the predetermined mapping.

### RELATED APPLICATION DATA

This applications claims the benefit of Swedish Patent Application No. 1830051-7, filed Feb. 15, 2018, the disclosure of which is incorporated herein by reference in its entirety.

### TECHNICAL FIELD OF THE INVENTION

The technology of the present disclosure relates generally to wireless communications among electronic devices in a network environment and, more particularly, to a method and apparatus for mapping base station beam patterns to paging resources.

### BACKGROUND

Demand for data traffic on wireless communication system continues to increase. Since widespread commercialization of fourth generation (4G) wireless systems, such as a Long Term Evolution (LTE) system or an LTE-Advanced (LTE-A) system standardized by the 3rd Generation Partnership Project (3GPP), next generation wireless systems are being developed. Once such system, by the 3GPP, is a fifth generation (5G) or New Radio (NR) wireless system.

To meet demand for higher data rates, wireless systems anticipate using unlicensed spectrum bands. High frequency bands (e.g. millimeter wave) can provide high data rates, but signal power may decrease quicker as signals propagate as compared to lower band systems. To provide a wider coverage area, beamforming techniques may be utilized at both a base station side and a user equipment (UE) side.

As development of 5G systems evolves, aspects of LTE and/or LTE-A systems are borrowed. Such aspects, however, were originally designed for lower frequency bands in which massive multiple-input, multiple-output (MIMO) setups are not typically deployed. Accordingly, leveraged aspects must account for multi-beam operations to be applicable in 5G systems. For instance, a 5G base station or gNB is known to utilize beam sweeping for synchronization during multi-beam operation. This technique enables a UE to acquire a synchronization signal block without prior setup of a best beam between the gNB and the UE. Paging of UEs introduces additional challenges during multi-beam operation. For instance, without an omnidirectional paging message, a UE may remain awake for a longer duration in order to acquire the paging message via the best beam and, thus, consume more battery power. Moreover, utilizing beam sweeping for the paging message in a manner similar to synchronization, would use a large amount of paging resources and possible increase latency.

### SUMMARY

The disclosed approach provides idle/inactive paging for multi-beam operations. A base station may operate to support a plurality of beams directed in different directions as opposed to utilizing an omnidirectional antenna. The base station may perform beam sweeping to enable synchronization. With beam sweeping, generally, the base station transmits information on each beam. The information transmitted may or may not be different for each beam. For synchronization, in particular, each beam may carry a synchronization signal block (SSB) in a different time slot such that, during sweeping, the SSB is transmitted on only one beam at a given time. The SSB may contain a primary synchronization signal (PSS), a secondary synchronization signal (SSS), and a physical broadcast channel (PBCH). In one example, at least the PBCH portion of an SSB may differ from beam to beam.

A user equipment (UE) may receive the SSB on one or more beams and determine a best or preferred transmit beam. When the UE is to be paged, the base station may not know the best or preferred transmit beam from the UE's perspective. Accordingly, the base station may utilize a form of beam sweeping for a paging message. In particular, a mapping may be configured between a synchronization signal block on a beam and resources for the paging message on a corresponding beam suitable to receive the paging message. Thus, once the UE determines the best transmit beam, the UE knows the resources of the paging message on the corresponding paging beam based on the mapping.

According to one aspect of the disclosure, a method paging for a base station in a wireless communication system operating with multiple beams includes transmitting a synchronization signal burst set by a beam sweep according to a first beam pattern; determining an allocation of paging resources for a second beam pattern for a paging operation according to a predetermined mapping based on the first beam pattern; and transmitting a paging message according to the second beam pattern using paging resources determined with the predetermined mapping.

According to one embodiment of the method, the predetermined mapping maps more than one beam of the first beam pattern to a single paging timeslot of the paging resources.

According to one embodiment of the method, the paging message is divided into a control part and a data part such that transmitting the page message includes: transmitting the control part according to the second beam pattern using a first subset of the paging resources; and transmitting the data part according to the second beam pattern using a second subset of the paging resources.

According to one embodiment of the method, the predetermined mapping maps a beam of the first beam pattern to more than one paging timeslot of the paging resources.

According to one embodiment of the method, the predetermined mapping allocates beams of the second beam pattern to paging resources on a frequency-first basis followed by time.

According to one embodiment of the method, the predetermined mapping allocates beams from a lowest frequency to a highest frequency of the paging resources.

According to one embodiment of the method, the predetermined mapping allocates beams across more than one bandwidth part of the wireless communication system.

According to one embodiment of the method, the predetermined mapping allocates a control portion of the paging message to an initial bandwidth part for all beams and allocates data portions of the paging message for the beams across the more than one bandwidth part.

According to one embodiment of the method, the control portion of the paging message includes pointers to the data portions in one or more bandwidth parts.

According to another aspect of the disclosure, a base station that operates with multiple beams includes a wireless interface over which wireless communications with electronic devices are carried out over multiple beams; and a control circuit configured to control paging by the base station, wherein the control circuit causes the base station to: transmit a synchronization signal burst set by a beam sweep according to a first beam pattern, wherein the first beam pattern specifies respective transmissions of respective synchronization signal blocks by respective beams in respective synchronization timeslots; determine an allocation of paging resources for a second beam pattern for a paging message based on the first beam pattern and according to a predetermined mapping that maps at least two beams of the first beam pattern to a particular time resource allocation or a particular frequency resource allocation; and transmit the paging message according to the second beam pattern using paging resources determined with the predetermined mapping.

According to one embodiment of the base station, the control circuit further causes the base station to provide the predetermined mapping to the electronic devices via radio resource control (RRC) signaling.

According to one embodiment of the base station, the base station transmits the paging message at least one within a periodicity corresponding to the synchronization signal burst set.

According to one embodiment of the base station, the predetermined mapping maps more than one beam of the first beam pattern to a single paging timeslot of the paging resources.

According to one embodiment of the base station, the predetermined mapping allocates beams to paging resources on a frequency-first basis followed by time.

According to another aspect of the disclosure, a method of receiving a paging message in an electronic device in a wireless communication system having multiple beams includes receiving a synchronization signal transmitted by a base station using a beam sweep of a plurality of beams according to a first beam pattern; identifying a preferred beam from the plurality of beams; determining paging resources corresponding to a paging message transmitted via the preferred beam based on a predetermined mapping; and receiving the paging message on the preferred beam at the paging resources determined according to the predetermined mapping.

According to one embodiment of the method, the predetermined mapping maps more than one beam of the plurality of beams to a single paging timeslot of the paging resources.

According to one embodiment of the method, the predetermined mapping maps a beam of the plurality of beams to more than one paging timeslot of the paging resources.

According to one embodiment of the method, the predetermined mapping allocates beams of the plurality of beams to paging resources on a frequency-first basis.

According to one embodiment of the method, the predetermined mapping allocates the beams from a lowest frequency to a highest frequency of the paging resources.

According to one embodiment of the method, the predetermined mapping allocates the beams across more than one bandwidth part of the wireless communication system.

According to one embodiment of the method, the predetermined mapping allocates a control portion of the paging message to an initial bandwidth part for all beams and allocates data portions of the paging message for the beams across the more than one bandwidth part.

According to another aspect of the disclosure, an electronic device includes a wireless interface over which wireless communications with a base station are carried out over multiple beams; and a control circuit configured to control paging, wherein the control circuit configures the electronic device to: receive a synchronization signal transmitted by a base station using a beam sweep of a plurality of beams according to a first beam pattern; identify a preferred beam from the plurality of beams; determine paging resources corresponding to a paging message transmitted via the preferred beam based on a predetermined mapping; and receive the paging message on the preferred beam at the paging resources determined according to the predetermined mapping.

### BRIEF DESCRIPTION OF THE DRAWINGS

FIG. 1 is a schematic block diagram of a network system that maps synchronization signal resources to paging resources for multi-beam wireless radio communications.

FIG. 2 is a schematic block diagram of an electronic device that forms part of the network system of FIG. 1.

FIG. 3 is a schematic diagram of the network system of FIG. 1 according to an aspect.

FIG. 4 is a schematic diagram of a general procedure to establish a connection in multi-beam operations.

FIG. 5 is a flow-diagram of a representative method of transmitting a paging message at a base station of the network system.

FIG. 6 is a flow-diagram of a representative method of receiving a paging message at an electronic device of the network system.

FIG. 7 is a schematic diagram of a mapping technique between synchronization signal resources and paging resources.

FIG. 8 is a schematic diagram of a mapping technique between synchronization signal resources and paging resources.

FIG. 9 is a schematic diagram of another mapping technique between synchronization signal resources and paging resources.

FIG. 10 is a schematic diagram of another mapping technique between synchronization signal resources and paging resources.

FIG. 11 is a schematic diagram of another mapping technique between synchronization signal resources and paging resources.

FIG. 12 is a schematic diagram of another mapping technique between synchronization signal resources and paging resources.

### DETAILED DESCRIPTION OF EMBODIMENTS

### Introduction

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below, in conjunction with the appended figures, are various embodiments of systems and methods for paging during multi-beam wireless radio communications. A mapping procedure may be carried out by the respective devices in an automated manner to identify corresponding paging resource. The mapping procedure described herein may reduce resource utilization for paging, provide efficient resource management, and allow dynamic configuration.

### System Architecture

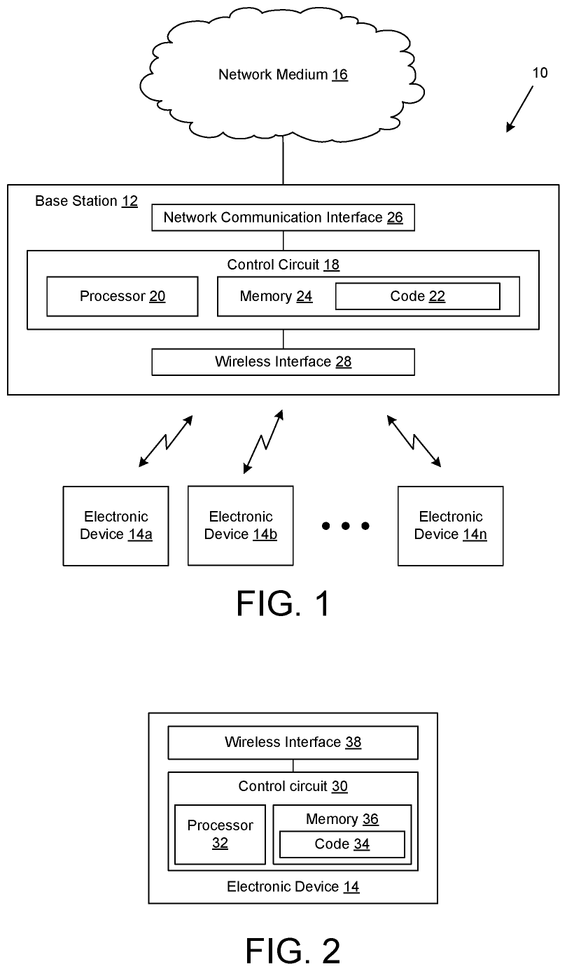

FIG. 1 is a schematic diagram of an exemplary network system 10 for implementing the disclosed techniques. It will be appreciated that the illustrated system is representative and other systems may be used to implement the disclosed techniques. The exemplary network system 10 includes a base station 12 that operates in accordance with a cellular protocol, such as a protocol promulgated by 3GPP or another standard. For instance, the network system 10 may operate in accordance with LTE, LTE-A, or a 5G NR standards. However, it is to be appreciated that the techniques described herein can be applied to substantially any wireless communication system that utilizes massive MIMO or multiple beams between respective devices.

The network system 10 of the illustrated example supports cellular-type protocols, which may include circuit-switched network technologies and/or packet-switched network technologies. The network system 10 includes a base station 12 that services one or more electronic devices 14, designated as electronic devices 14a through 14n in FIG. 1. The base station 12 may support communications between the electronic devices 14 and a network medium 16 through which the electronic devices 14 may communicate with other electronic devices 14, servers, devices on the Internet, etc. The base station 12 may be an access point, an evolved NodeB (eNB) in a 4G network or a next generation NodeB (gNB) in a 5G or NR network. As utilized herein, the term “base station” may refer, generally, to any device that services user devices and enables communications between the user devices and the network medium and, thus, includes the specific examples above depending on the network implementation.

In one embodiment, the network system 10 supports multi-beam operations between the base station 12 and the electronic devices 14 such that the base station 12 can transmit using a plurality of beams (generated with beamforming techniques, for example) and the electronic devices 14 can receive using one or more reception beams. During multi-beam operations, the base station 12 may retransmit certain messages (with or without differences) using each available transmit beam, which is referred to as beam sweeping. In particular, such beam sweeping may occur when the base station 12 communicates information to electronic devices 14 before establishing a specific, known beam for each electronic device 14. For example, beam sweeping may be used for synchronization and paging messages. To provide efficient resource management and reduced latency, techniques described herein provide a configurable mapping between resources utilized for a synchronization signal block (i.e. containing PSS, SSS, and BCH) for a particular beam and resource utilized for a paging message for a corresponding beam. In other words, the configurable mapping associates an SSB beam or beams to one or more paging beams suitable for reception of the paging message. The paging message, as described herein, may include a control part on a physical downlink control channel (PDCCH) and a data part on a physical downlink shared channel (PDSCH). As utilized herein, the term “resources” may refer to radio resources identifiable in a time domain, in a frequency domain, or in both time and frequency domains, according to an underlying structure of a physical radio interface utilized by the network system 10 and implemented by the wireless interfaces 28 and 38. It will be understood that mapping synchronization resources to paging resources may involve division and/or multiplexing in the time domain, in the frequency domain, or both.

The base station 12 may include operational components for carrying out the wireless communications, the resource mapping described herein and other functions of the base station 12. For instance, the base station 12 may include a control circuit 18 that is responsible for overall operation of the base station 12, including controlling the base station 12 to carry out the operations described in greater detail below. The control circuit 18 includes a processor 20 that executes code 22, such as an operating system and/or other applications. The functions described in this disclosure document may be embodied as part of the code 22 or as part of other dedicated logical operations of the base station 12. The logical functions and/or hardware of the base station 12 may be implemented in other manners depending on the nature and configuration of the base station 12. Therefore, the illustrated and described approaches are just examples and other approaches may be used including, but not limited to, the control circuit 18 being implemented as, or including, hardware (e.g., a microprocessor, microcontroller, central processing unit (CPU), etc.) or a combination of hardware and software (e.g., a system-on-chip (SoC), an application-specific integrated circuit (ASIC), etc.).

The code 22 and any stored data (e.g., data associated with the operation of the base station 12) may be stored on a memory 24. The code may be embodied in the form of executable logic routines (e.g., a software program) that is stored as a computer program product on a non-transitory computer readable medium (e.g., the memory 24) of the base station 12 and is executed by the processor 20. The functions described as being carried out by the base station 12 may be thought of as methods that are carried out by the base station 12.

The memory 24 may be, for example, one or more of a buffer, a flash memory, a hard drive, a removable media, a volatile memory, a non-volatile memory, a random access memory (RAM), or other suitable device. In a typical arrangement, the memory 24 includes a non-volatile memory for long term data storage and a volatile memory that functions as system memory for the control circuit 18. The memory 24 is considered a non-transitory computer readable medium.

The base station 12 includes communications circuitry that enables the base station 12 to establish various communication connections. For instance, the base station 12 may have a network communication interface 26 to communicate with the network medium 16. Also, the base station 12 may have a wireless interface 28 over which wireless communications are conducted with the electronic devices 14, including the multi-beam operations and paging procedures described herein. The wireless interface 28 may include a radio circuit having one or more radio frequency transceivers (also referred to as a modem), at least one antenna assembly, and any appropriate tuners, impedance matching circuits, and any other components needed for the various supported frequency bands and radio access technologies.

The electronic devices 14 serviced by the base station 12 may be user devices (also known as user equipment or UEs) or machine-type devices. Exemplary electronic devices 14 include, but are not limited to, mobile radiotelephones (“smartphones”), tablet computing devices, computers, a device that uses machine-type communications, machine-to-machine (M2M) communications or device-to-device (D2D) communication (e.g., a sensor, a machine controller, an appliance, etc.), a camera, a media player, or any other device that conducts wireless communications with the base station 12.

As shown in FIG. 2, each electronic device 14 may include operational components for carrying out the wireless communications, the resource mapping described herein and other functions of the electronic device 14. For instance, among other components, each electronic device 14 may include a control circuit 30 that is responsible for overall operation of the electronic device 14, including controlling the electronic device 14 to carry out the operations described in greater detail below. The control circuit 30 includes a processor 32 that executes code 34, such as an operating system and/or other applications. The functions described in this disclosure document may be embodied as part of the code 34 or as part of other dedicated logical operations of the electronic device 14. The logical functions and/or hardware of the electronic device 14 may be implemented in other manners depending on the nature and configuration of the electronic device 14. Therefore, the illustrated and described approaches are just examples and other approaches may be used including, but not limited to, the control circuit 30 being implemented as, or including, hardware (e.g., a microprocessor, microcontroller, central processing unit (CPU), etc.) or a combination of hardware and software (e.g., a system-on-chip (SoC), an application-specific integrated circuit (ASIC), etc.).

The code 34 and any stored data (e.g., data associated with the operation of the electronic device 14) may be stored on a memory 36. The code 34 may be embodied in the form of executable logic routines (e.g., a software program) that is stored as a computer program product on a non-transitory computer readable medium (e.g., the memory 36) of the electronic device 14 and is executed by the processor 32. The functions described as being carried out by the electronic device 14 may be thought of as methods that are carried out by the electronic device 14.

The memory 36 may be, for example, one or more of a buffer, a flash memory, a hard drive, a removable media, a volatile memory, a non-volatile memory, a random access memory (RAM), or other suitable device. In a typical arrangement, the memory 36 includes a non-volatile memory for long term data storage and a volatile memory that functions as system memory for the control circuit 30. The memory 36 is considered a non-transitory computer readable medium.

The electronic device 14 includes communications circuitry that enables the electronic device 14 to establish various communication connections. For instance, the electronic device 14 may have a wireless interface 38 over which wireless communications are conducted with the base station 12, including the multi-beam operations and paging procedures described herein. The wireless interface 38 may include a radio circuit having one or more radio frequency transceivers (also referred to as a modem), at least one antenna assembly, and any appropriate tuners, impedance matching circuits, and any other components needed for the various supported frequency bands and radio access technologies.

Other components of the electronic device 14 may include, but are not limited to, user inputs (e.g., buttons, keypads, touch surfaces, etc.), a display, a microphone, a speaker, a camera, a sensor, a jack or electrical connector, a rechargeable battery and power supply unit, a SIM card, a motion sensor (e.g., accelerometer or gyro), a GPS receiver, and any other appropriate components.

### Paging Procedures for Multi-beam Operations

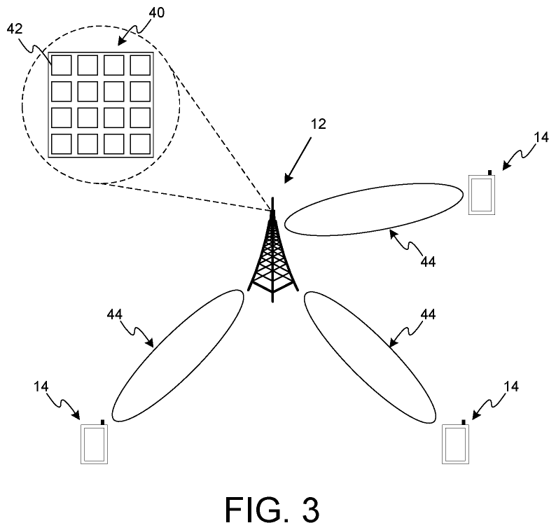

With reference to FIG. 3, network system 10 may support multi-beam operations. Base station 12 may include a large antenna array 40 comprising individual antenna elements 42. In an aspect, each antenna element 42 may be coupled to a respective radio chain of base station 12. The base station 12 may use beam forming technique with the antenna array 40 to generate a plurality of transmit beams 44 directed to electronic devices 14.

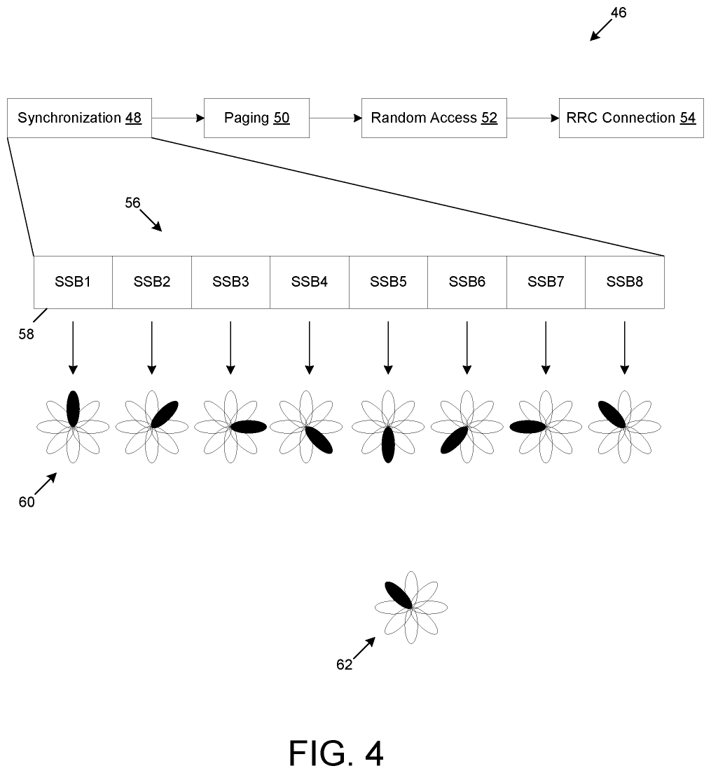

Turning to FIG. 4, shown is an exemplary schematic diagram depicting a general procedure 46 for a base station (e.g. base station 12) and a UE (e.g. electronic device 14) prior to establishing an RRC connection. In an example, for mobile terminating traffic (i.e. downlink data initiate by the network), the UE may be configured to receive a paging message 50 at a predetermined timing (e.g., based on a discontinuous reception (DRX) cycle) to inform the UE that data is waiting. After receiving the paging message 50, the UE performs a random access procedure 52 to establish the RRC connection 54.

Prior to receiving the paging message 50, the UE may perform synchronization 48 with the base station. For multi-beam operation, the base station may transmit a synchronization signal (SS) burst set 56 that includes a synchronization signal block (SSB) 58 for each beam 60 employed by the base station. In the example depicted in FIG. 4 and utilized throughout this description, the base station utilizes eight transmit beams. It is to be understood, however, that the base station may employ substantially any number of beams and that the beam number examples utilized herein are constructed for descriptive purposes and are not to be considered limiting. In some implementations, the base station may utilize up to 64 beams for the SSB transmissions.

As shown in FIG. 4, the SS burst set 56 may be divided in the time domain such that the SSB 58 for each beam 60 is transmitted in a different time slot. During synchronization 48, the UE may identify a best or preferred beam 62 for reception. According to an aspect, the preferred beam 62 may be a reception beam that corresponds to a particular transmit beam 60 of the base station. For paging while the UE may have identified the preferred beam 62 during synchronization 48, the base station may still be unaware of which beam is perceived as a best beam from the point of view of the UE. In other words, the base station may not know whether the UE is reachable or whether beam 62 is the best beam for the UE as no reporting from the UE is received at this stage. Thus, in some examples, the base station may employ a beam sweeping technique similar to the beam sweeping employed for synchronization. That is, the base station may repeat the same paging message multiple time (e.g. one time for each beam). To support this technique, each paging occasion may be subdivided into timeslots and each beam transmits the paging message in a different timeslot.

When the UE has synchronized to one of the transmit beams 60 of the base station (i.e. identified the preferred beam 62), the UE may know which timeslot of the paging occasion on which to receive the paging message with the preferred beam 62. For instance, configuration information may specify a correspondence between a synchronization beam and a paging beam. That is, the base station may inform the UE of a mapping between transmit beam and paging timeslot. With this mapping, the UE may not need to stay awake for an entire paging operation and may only wake for a particular timeslot corresponding to the preferred beam 62, for example. With this approach, however, the amount of paging resources consumed as well latency may increase as the number of beams employed the base station increases.

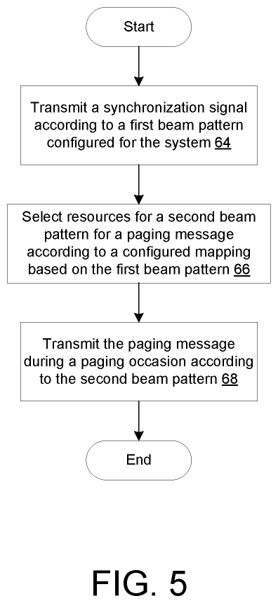

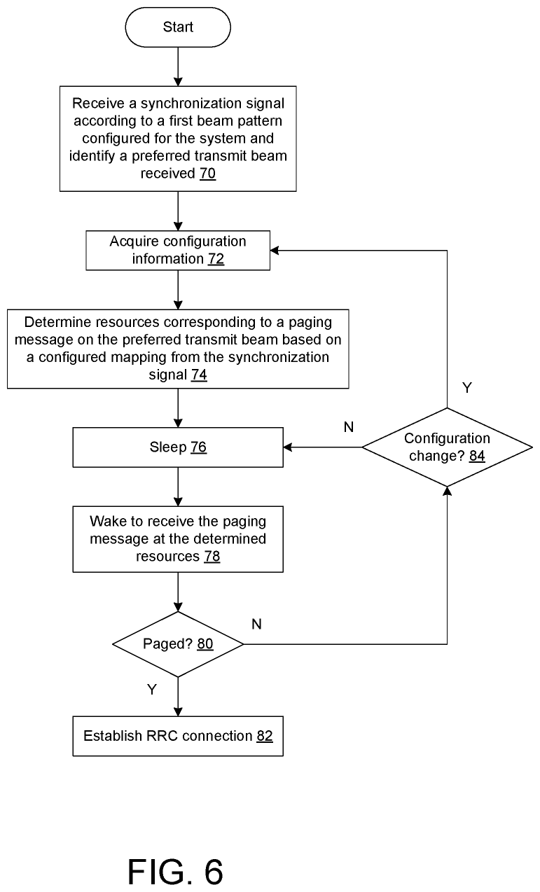

With reference to FIG. 5, shown is an exemplary flow diagram representing steps that may be carried out by the base station 12 when executing logical instructions to carry out paging during multi-beam for wireless radio communications. Complimentary operations of the electronic device 14 are shown FIG. 6, which shows an exemplary flow diagram representing steps that may be carried out by the electronic device 14 when executing logical instructions to carry out paging during multi-beam for wireless radio communications. Although illustrated in a logical progression, the blocks of FIGS. 5 and 6 may be carried out in other orders and/or with concurrence between two or more blocks. Therefore, the illustrated flow diagrams may be altered (including omitting steps or adding steps not shown in order to enhance description of certain aspects) and/or may be implemented in an object-oriented manner or in a state-oriented manner. Also, the method represented by FIG. 5 may be carried out apart from the method of FIG. 6 and vice versa.

Referring to actions carried out by the base station 12, the logical flow of performing a paging operation may start in block 64. In block 64, it may be assumed that base station 12 employs multiple transmit beams to communicate with electronic devices 14. Thus, in block 64, the base station 12 transmits a synchronization signal (SS) using beam sweeping according to a first beam pattern configured for the system. The base station 12 transmits a (SS) burst set mapped to particular timeslots. For each timeslot, the base station 12 transmits a synchronization signal block (SSB) on a particular beam. As utilized herein, the first beam pattern refers to a sequence of beams, in the time domain, employed to transmit the SSB. That is, the first beam pattern specifies the transmit beam utilized for each timeslot of the SS burst set.

During operation, electronic devices 14 may be idle or inactive and, thus, switching between a sleep state and an active state according to a DRX cycle. In this state, electronic devices 14 can be paged in order to be alerted to certain situations. For instance, a page of the electronic devices 14 may be initiated by a core network (e.g. a mobility management entity) in case of incoming mobile terminated traffic or by the base station 12 in the case of changing system information or an emergency (e.g. a public warning message initiated by a public warning system (PWS)).

To support paging procedure during multi-beam operations, a paging occasion may be divided in a plurality of paging timeslots. In one embodiment, the plurality of paging timeslots may include one or more timeslots, up to a number of timeslots correspond to the number of beams employed by the base station 12. In another embodiment, the plurality of paging timeslots may include a multiple of the number of beams. For example, to minimize paging failures, a particular beam may be used to transmit a paging message in more than one paging timeslot.

In block 66, the base station 12 determines resources for a second beam pattern for a paging operation. In one embodiment, the resources can be determined according to a configured mapping of SSB resources to paging resources and based on the first beam pattern. That is, the resources utilized by a particular beam to transmit the SSB can map to particular paging resources utilized to transmit a paging message for that beam. According to another embodiment, an index or other identifier of a particular beam that carried the SSB during transmission of the SS burst set can map to the particular paging resources for the paging message using a corresponding beam. Accordingly, the mapping provides a corresponding resource for a paging message for each beam employed to transmit the SSB during beam sweeping with the SS burst set. The base station 12 transmits a paging message during a paging occasion according to the second beam pattern and the determined resources in block 68.

The mapping may allocate paging resources to specific beams that are divided in the time domain, the frequency domain, or both. Moreover, the mapping may be a many-to-one mapping such that, for the first beam pattern, more than one beam maps to a same time resource (i.e. time slot), a same frequency resource, or both. In other words, a specific paging resource may be utilized, by more than one beam that transmitted the SSB, to transmit a paging message

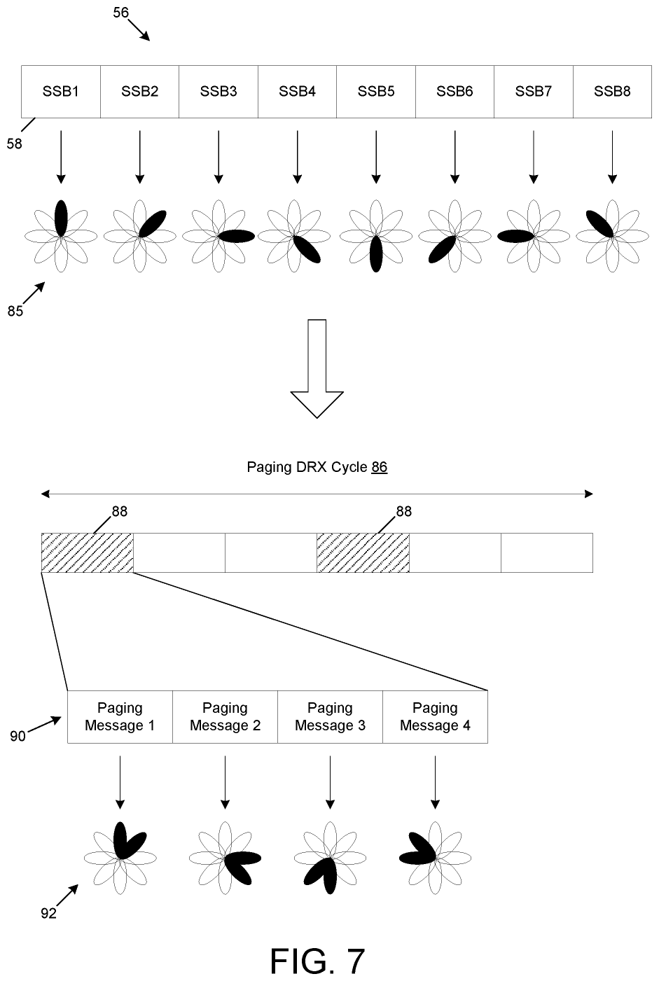

Turning briefly to FIG. 7, one exemplary mapping is depicted. In this example, the SS burst set 56 can be transmitted with a first beam pattern 85 such that each beam of the first beam pattern 85 corresponds to a respective SSB 58. For a paging DRX cycle 86, the base station 12 may transmit paging messages in one or more paging occasions 88. A paging occasion is divided into set of timeslots 90 and, during each timeslot, the paging message is transmitted by base station 12 using one or more transmit beams. As particularly shown in FIG. 7, according to one example, the base station 12 may transmit the paging message with a second beam pattern 92. The second beam pattern 92 may include two beams from the first beam pattern 85 per timeslot or, alternatively, the second beam pattern 92 may include wider beams that generally correspond to the two beams of the first beam pattern 85, respectively. In either situation, as shown in FIG. 7, the first two beams of the first beam pattern 85 (which respectively transmitted SSB1 and SSB2) can map to paging message 1 transmitted by the first beam of the second beam pattern 92. It is to be understood that the mapping may provide for three or more beams during per timeslot (or a wide beam that corresponds to the three or more beams) or some other mapping. The base station 12 may utilize the same beam pattern (i.e. maintain the second beam pattern 92) for a subsequent paging occasion until a new configuration is established.

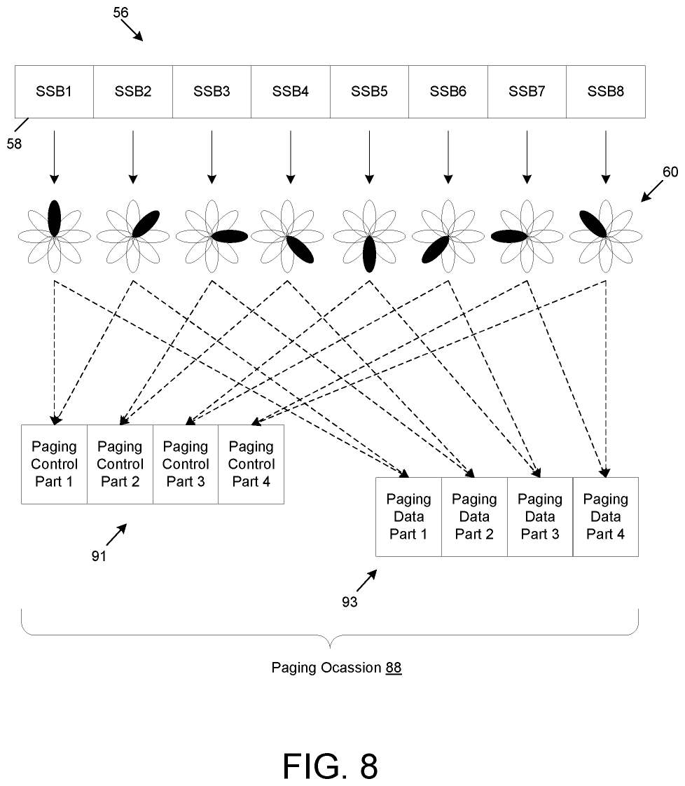

In a related exemplary mapping illustrated in FIG. 8, the paging message is split into a paging control part 91 (e.g. downlink control information (DCI)) and a paging data part 93 for a given paging occasion 88. Given the first beam pattern 85, a second beam pattern is determined. As shown in FIG. 8, the second beam pattern (for example, beam pattern 92 from FIG. 7) is employed for both the paging control part 91 and the paging data part 93.

In another embodiment, the base station 12 may transmit the paging message on a beam or a set of beams in more than one timeslot if configured with a one-to-many or a many-to-many mapping. In this embodiment, the base station 12 may utilize a first subset of beams in one paging occasion 88 in the cycle 86 and a second subset of beams in another paging occasion 88 in the cycle 86. To this end, according to another aspect, base station 12 may transmit a full paging set (i.e. a paging message for every beam that transmits the SSB) within the SS burst set periodicity. It is to be understood that the base station 12 may guarantee at least one paging occasion between two consecutive SS burst sets even when one paging occasion contains all beams.

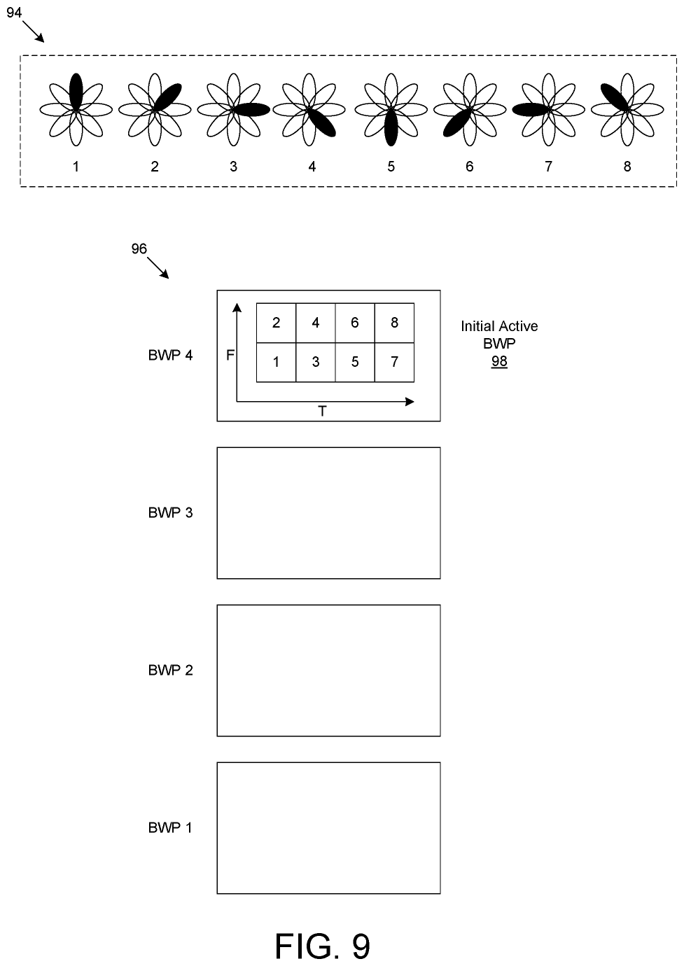

Referring to FIGS. 9-11, other exemplary mappings are illustrated. In 5G systems, and particularly in a millimeter wave frequency range, the bandwidth may be wide. A wide bandwidth may be divided into multiple bandwidth parts. Given this system configuration, a beam pattern for SSB transmissions may be mapped, not only in time, but also in frequency. In one embodiment, the mapping follows a frequency-first rule such that mappings occur in the frequency domain before occurring in the time domain.

As shown in FIGS. 9-11, for a given beam pattern 94 employed to transmit the SS burst set, various frequency-based mappings may be utilized by the base station 12 to transmit paging messages. According to a first technique 96 shown in FIG. 9, an initial active bandwidth part (BWP) 98 may be wide enough for a frequency division multiplexing (FDM) of a paging timeslot to be entirely located in the initial active BWP 98 as shown in FIG. 9. The initial active BWP 98 may be the BWP that contained the SS burst set transmission. According to technique 96, the paging beam pattern may be transmitted in timeslots that are placed consecutively (in time) with no gaps and beams may be arranged from a lowest frequency to a highest frequency available in a timeslot before mapping to a subsequent timeslot.

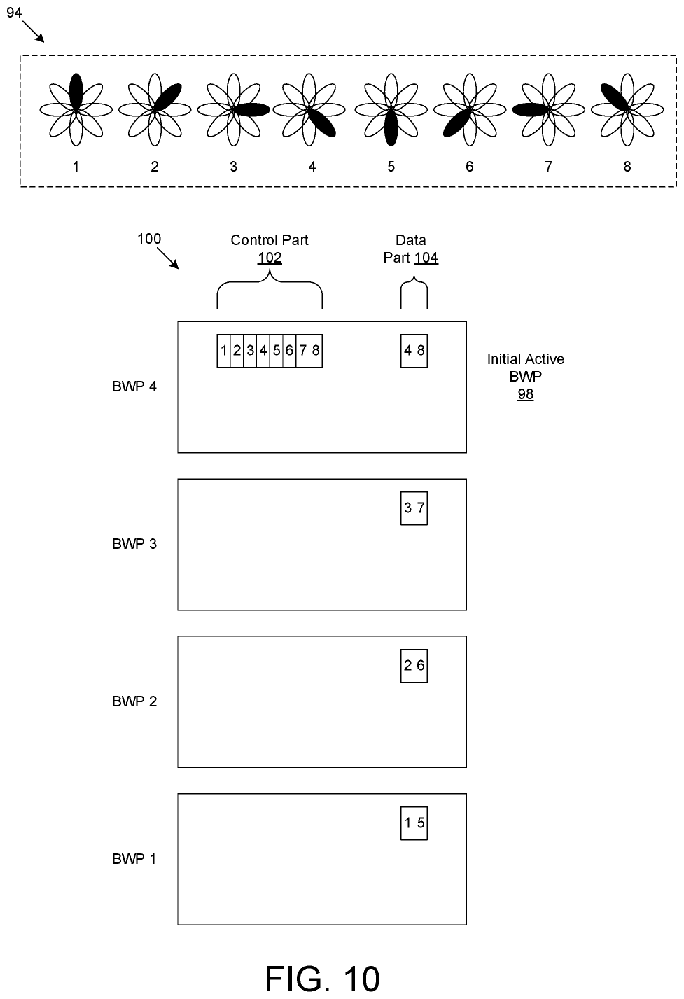

In a second technique 100 shown in FIG. 10, the FDM of a paging timeslot extends to other BWPs. Technique 100 may be utilized when the width of the initial active BWP 98 is relatively small. The paging message may include a control part 102 and a data part 104. The control part 102 is located on the initial active BWP 98 and the data part 104 is allocated across other BWPs. Similar to the first technique 96, the beam pattern for the data part 104 is arranged from a lowest frequency (or BWP) to a highest frequency (or BWP) before mapping to a subsequent timeslot.

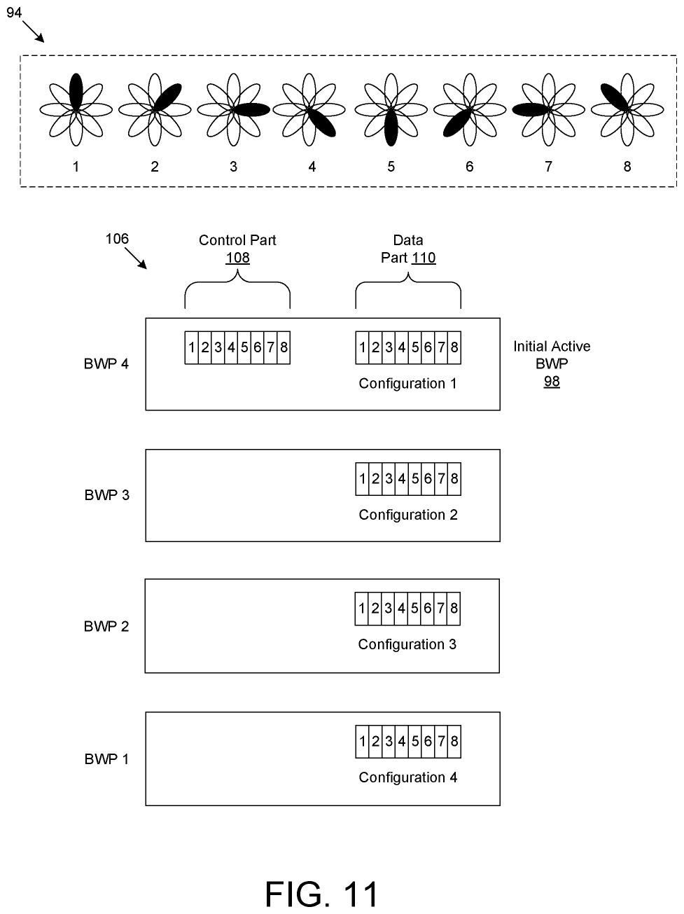

In a third technique 106, the paging message may be split into a control part 108 and a data part 110. The control part 108 is located on the initial active BWP 98 and includes pointers to the data part 110, which may be located in any of the BWPs. Accordingly, the base station 12 may dynamically utilize one of configurations 1-4 for the data part 110. In other words, the base station 12 may dynamically move the data part 110 to different BWPs in response to loading conditions. While FIG. 11 depicts 4 configurations, it is to be understood that the control part 108 may indicate up to N configurations, where N equals a number of bandwidth parts configured. In another embodiment, more than N configurations may be available. For instance, the base station 12 may additional divide a complete paging beam pattern for the data portion 110 between multiple BWPs as shown in FIG. 10.

Referring back to FIG. 6, exemplary actions carried out by the electronic device 14 are illustrated. The actions carried out by the electronic device 14 may, in some case, be complementary to the actions carried out by the base station 12, which were described above. The logical flow of conducting anchor channel control by the electronic device 14 may start in block 70. In block 70, it may be assumed that electronic device 14 carries out wireless communications with the base station 12 utilizing multiple receive beams. In block 70, the electronic device 14 receives a synchronization signal block, which is transmitted by base station 12 according to the first beam pattern, and identifies the preferred beam. The first beam pattern may include a beam sweeping pattern of a plurality of transmit beams, wherein each transmit beam carries a corresponding SSB. Based on the SSB received by the electronic device, the electronic device 14 identifies the corresponding beam on which the SSB was transmitted.

The electronic device 14 acquires configuration information from base station 12 in block 72. The configuration information may include a mapping of the first beam pattern (i.e. transmit beam indexes or transmit beam resources) to paging resources (i.e. paging timeslot and/or frequency) or paging beams. The configuration information may be provided to the electronic device 14 using RRC signaling. For instance, the mapping may be provided as remaining minimum system information (RMSI).

In block 74, the electronic device 14 determines resources corresponding to a paging message associated with the preferred beam. The resources are determined based on the mapping provided in acquired configuration information. The mapping may be a mapping similar to those described above with respect to FIGS. 5 and 7-11.

In block 76, the electronic device 14 is assumed to be in DRX mode and sleeps (i.e. powers down). In block 78, the electronic device 14 wakes to receive the paging message according to the determined resources corresponding to the preferred beam. In block 80, the electronic device 14 determines whether it is being paged. That is, the electronic device 14 determines if its identity is found in the paging message. If so, the electronic device 14 establishes an RRC connection in block 82. If the electronic device 14 determines it is not being paged, then the electronic device 14 determines, in block 84, if there is configuration change. If so, the electronic device 14 acquires new configuration information in block 72 and determines new resources corresponding to the preferred beam based on the new mapping. If the mapping is unaltered, the electronic device 14 beings another DRX cycle in block 76.

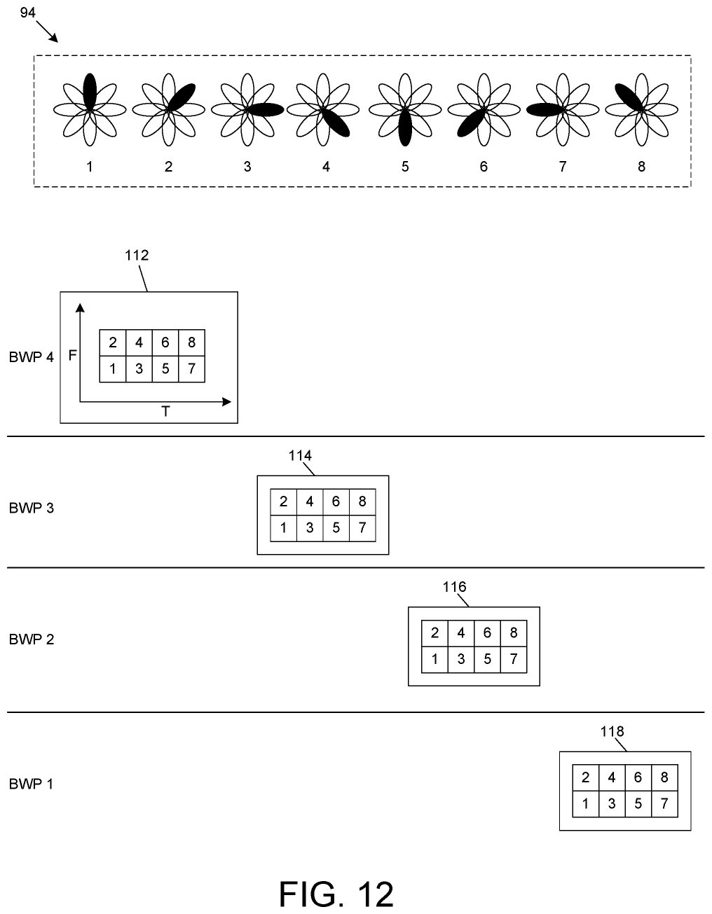

Referring now to FIG. 12, illustrated is another aspect of paging according to an exemplary embodiment. A paging occasion for the paging message is typically determined based on an UE identifier (e.g. IMSI) and a DRX period. As shown in FIG. 12, the paging occasion may also be a function of BWP such that paging occasions 112-118 occur in different BWPs.

### CONCLUSION

Although certain embodiments have been shown and described, it is understood that equivalents and modifications falling within the scope of the appended claims will occur to others who are skilled in the art upon the reading and understanding of this specification.

1. A method of paging for a base station in a wireless communication system, the base station operating multiple beams, the method comprising:
transmitting a synchronization signal burst set by a beam sweep according to a first beam pattern;
determining an allocation of paging resources for a second beam pattern for a paging operation according to a predetermined mapping based on the first beam pattern, wherein the predetermined mapping maps more than one beam of the first beam pattern to a single paging timeslot of the paging resources; and
transmitting a paging message according to the second beam pattern using paging resources selected with the predetermined mapping.

2. The method of claim 1, wherein the paging message is divided into a control part and a data part such that the transmitting of the page message comprises:
transmitting the control part according to the second beam pattern using a first subset of the paging resources; and
transmitting the data part according to the second beam pattern using a second subset of the paging resources.

3. The method of claim 1, wherein the predetermined mapping further maps a beam of the first beam pattern to more than one paging timeslot of the paging resources.

4. The method of claim 1, wherein the predetermined mapping allocates beams of the second beam pattern to paging resources on a frequency-first basis followed by time such that mappings occur in the frequency domain before occurring in the time domain.

5. The method of claim 4, wherein the predetermined mapping allocates beams from a lowest frequency to a highest frequency of the paging resources.

6. The method of claim 1, wherein the predetermined mapping allocates beams across more than one bandwidth part of the wireless communication system, and wherein the predetermined mapping allocates a control portion of the paging message to an initial bandwidth part for all beams and allocates data portions of the paging message for the beams across the more than one bandwidth part.

7. (canceled)

8. The method of claim 6, wherein the control portion of the paging message includes pointers to the data portions in one or more bandwidth parts.

9. A base station that operates multiple beams, comprising:
a wireless interface over which wireless communications with electronic devices are carried out over multiple beams; and
a control circuit configured to control paging by the base station, wherein the control circuit causes the base station to:
transmit a synchronization signal burst set by a beam sweep according to a first beam pattern, wherein the first beam pattern specifies respective transmissions of respective synchronization signal blocks by respective beams in respective synchronization timeslots;
determine an allocation of paging resources for a second beam pattern for a paging message based on the first beam pattern and according to a predetermined mapping that maps at least two beams of the first beam pattern to a single paging timeslot of the paging resources; and
transmit the paging message according to the second beam pattern using paging resources determined with the predetermined mapping.

10. The base station of claim 9, wherein the control circuit further causes the base station to provide the predetermined mapping to the electronic devices via radio resource control, RRC, signaling.

11. The base station of claim 9, wherein the base station transmits the paging message at least once within a periodicity corresponding to the synchronization signal burst set.

12. The base station of claim 9, wherein the predetermined mapping maps more than one beam of the first beam pattern to a single paging timeslot of the paging resources.

13. The base station of claim 9, wherein the predetermined mapping allocates beams to paging resources on a frequency-first basis.

14. A method of receiving a paging message in an electronic device operating in a wireless communication system, the wireless communication system comprising a base station operating multiple beams, comprising:
receiving a synchronization signal transmitted by a base station using a beam sweep of a plurality of beams according to a first beam pattern;
identifying a preferred beam from the plurality of beams;
determining paging resources corresponding to a paging message transmitted via the preferred beam based on a predetermined mapping; and
receiving the paging message on the preferred beam at the paging resources determined according to the predetermined mapping.

15. The method of claim 14, wherein the predetermined mapping maps more than one beam of the plurality of beams to a single paging timeslot of the paging resources.

16. The method of claim 14, wherein the predetermined mapping maps a beam of the plurality of beams to more than one paging timeslot of the paging resources.

17. The method of claim 14, wherein the predetermined mapping allocates beams of the plurality of beams to paging resources on a frequency-first basis followed by time.

18. The method of claim 17, wherein the predetermined mapping allocates the beams from a lowest frequency to a highest frequency of the paging resources.

19. The method of claim 14, wherein the predetermined mapping allocates the beams across more than one bandwidth part of the wireless communication system.

20. The method of claim 19, wherein the predetermined mapping allocates a control portion of the paging message to an initial bandwidth part for all beams and allocates data portions of the paging message for the beams across the more than one bandwidth part.

21. An electronic device, comprising:
a wireless interface over which wireless communications with a base station are carried out, wherein the base station operates multiple beams; and
a control circuit configured to control paging by the electronic device, wherein the control circuit configures the electronic device to carry of the method according to claim 14.
